(19) United States
(12) Patent Application Publication
(10) Pub. No.: US 2021/0310534 A1
(43) Pub. Date: Oct. 7, 2021

(54) COIL-INTEGRATED MAGNETO-RHEOLOGICAL ELASTOMER

(71) Applicants: HYUNDAI MOTOR COMPANY, Seoul (KR); KIA MOTORS CORPORATION, Seoul (KR)

(72) Inventor: Young Min KIM, Siheung-si (KR)

(21) Appl. No.: 17/036,654

(22) Filed: Sep. 29, 2020

(30) Foreign Application Priority Data
Apr. 2, 2020 (KR) 10-2020-0040563

(51) Int. Cl. F16F 1/36; H01F 1/06; H01F 41/02

(52) U.S. Cl. CPC F16F 1/361; H01F 1/06; F16F 2238/028; F16F 2222/06; F16F 2224/045; H01F 41/02

(57) ABSTRACT

A coil-integrated magneto-rheological elastomer includes: an elastomer substrate having a predetermined shape and including a magnetic powder; and a coil disposed inside the elastomer substrate. Such a coil-integrated magneto-rheological elastomer can exhibit improved magnetic properties due to the coil embedded in the elastomer substrate.

### CROSS-REFERENCE TO RELATED APPLICATION

This application claims the priority benefit of Korean Patent Application No. 10-2020-0040563, filed on Apr. 2, 2020 in the Korean Intellectual Property Office, the disclosure of which is incorporated herein by reference.

### TECHNICAL FIELD

The present disclosure relates to a coil-integrated magneto-rheological elastomer, and more particularly, to a coil-integrated magneto-rheological elastomer, which is capable of improving magnetic properties by embedding a coil in an elastomer substrate.

### BACKGROUND

A magneto-rheological material is a material that has rheologic properties and dynamic characteristics that vary upon application of an external magnetic field.

Magneto-rheological materials are classified into magneto-rheological fluid (MRF), magneto-rheological foam, magneto-rheological elastomers (MRE), and the like.

In recent years, a magneto-rheological elastomer that includes a matrix constituted by an elastomer is increasingly used in place of a magneto-rheological fluid, application of which is limited because the particles in the fluid matrix precipitate during storage or there is a need for an additional container for storing the matrix.

Particularly, since the magneto-rheological elastomer (MRE) varies in modulus and exhibits a magneto-rheological effect on application of a magnetic field, the magneto-rheological elastomer (MRE) is extensively used in fields such as those of damping components, shock absorbers, noise-shielding systems, insulators and magneto-register sensors. Particularly, technology for applying the magneto-rheological elastomer to the field of manufacture of vibration-proofing components of vehicles is continually researched.

FIG. 1 is a view illustrating a transmission mount to which a conventional magneto-rheological elastomer is applied. FIG. 2A is a view illustrating a magnetic field created in the conventional magneto-rheological elastomer. FIG. 2B is a schematic view illustrating the conventional magneto-rheological elastomer before and after a magnetic field is created.

As illustrated in FIG. 1, the transmission mount to which the conventional magneto-rheological elastomer is applied includes a plurality of core components 11, 12, 13 and 14, a bracket 20, a magneto-rheological elastomer 40, which is disposed at a position to which stress is applied, and a bobbin 30 around which a coil 31 is wound so as to create a magnetic field around the magneto-rheological elastomer 40. Here, the magneto-rheological elastomer 40 is prepared separately from the coil 31 such that the magnetic field generated by the coil 31 constitutes a long closed circuit through the magneto-rheological elastomer 40.

Here, the magneto-rheological elastomer 40 is composed of an elastomer substrate 41 and magnetic powder 42, which is magnetic reactive particles, included in the elastomer substrate 41, as illustrated in FIG. 2B. Generally, carbonyl iron power (CIP), which is composed of spherical particles, is used as the magnetic powder 42.

When power is applied to the coil 31, a magnetic field is created in the magneto-rheological elastomer 40, as illustrated in FIG. 2A. However, a uniform magnetic field E is not created in the magneto-rheological elastomer 40 but a phenomenon in which the magnetic field E is concentrated in a certain direction occurs due to the position and closed-circuit shape of the coil 31. Because a non-uniform electromagnetic gradient is formed in the magneto-rheological elastomer 40, there is a problem whereby the magneto-rheological elastomer 40 is only partially operated.

Furthermore, because the transmission mount to which the conventional magneto-rheological elastomer 40 is applied is constructed such that the magneto-rheological elastomer 40 is disposed so as to be spaced apart from the coil 31, a long path of the magnetic field E is created from the coil 31 to the magneto-rheological elastomer 40.

Hence, in order to enhance the intensity of the magnetic field E, various ways for increasing the number of turns of the coil 31, increasing the intensity of current applied to the coil 31 or increasing the volume of the magneto-rheological elastomer 40 must be applied. However, there is a disadvantage in that the ways for enhancing the magnetic field E are extremely inefficient.

Furthermore, because the magneto-rheological elastomer 40 is disposed so as to be spaced apart from the coil 31, there is a problem in that electromagnetic leakage occurs, and the electromagnetic leakage has an adverse influence on peripheral components.

Details described as the background art are intended merely for the purpose of promoting understanding of the background of the present disclosure and should not be construed as an acknowledgment of the prior art that is previously known to those of ordinary skill in the art.

### SUMMARY

The present disclosure has been made in view of the above problems, and it is an object of the present disclosure to provide a coil-integrated magneto-rheological elastomer, which is capable of improving magnetic properties by embedding a coil in an elastomer substrate.

In accordance with the present disclosure, a coil-integrated magneto-rheological elastomer includes: an elastomer substrate having a predetermined shape and including a magnetic powder included; and a coil disposed inside the elastomer substrate.

The coil may be wound in a direction perpendicular to a direction in which stress is applied to the elastomer substrate.

The magnetic powder may be magnetic powder including flaky particles, and may be included in the elastomer substrate such that a flat surface of the magnetic powder including the flaky particles is perpendicular to the direction in which the stress is applied to the elastomer substrate.

The magnetic powder may be magnetic powder including spherical particles.

The coil may include a plurality of coils, which are wound in directions different from each other.

The magnetic powder may be magnetic powder including spherical particles.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a view illustrating a transmission mount to which a conventional magneto-rheological elastomer is applied;

FIG. 2A is a view illustrating a magnetic field created in the conventional magneto-rheological elastomer;

FIG. 2B is a schematic view illustrating the conventional magneto-rheological elastomer before and after a magnetic field is created;

FIG. 3 is a view illustrating a magneto-rheological elastomer according to an embodiment of the present disclosure; and

FIGS. 4A to 4C are views illustrating magneto-rheological elastomers according to other embodiments of the present disclosure.

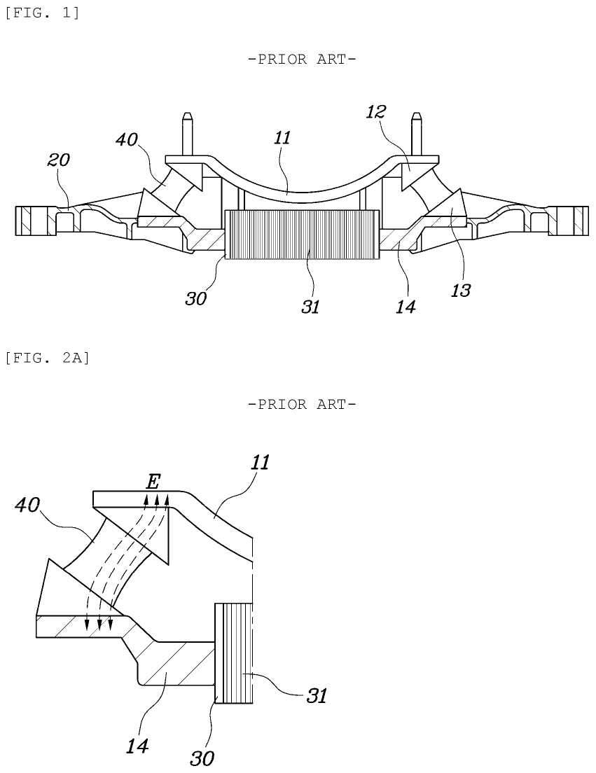

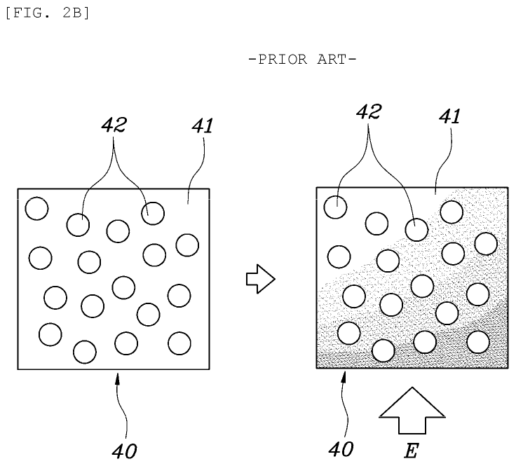

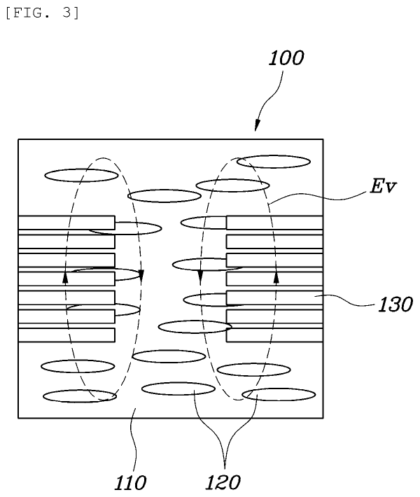

### DETAILED DESCRIPTION

Reference will now be made in detail to preferred embodiments of the present disclosure, examples of which are illustrated in the accompanying drawings. Wherever possible, the same reference numbers will be used throughout the drawings to refer to the same or like parts.

Hereinafter, embodiments of the present disclosure will be described in detail with reference to the accompanying drawings. However, the present disclosure may be embodied in many different forms and should not be construed as being limited to the embodiments set forth herein. Rather, these embodiments are provided so that this disclosure will be thorough and complete, and will fully convey the scope of the disclosure to those skilled in the art. Wherever possible, the same reference numbers will be used throughout the drawings to refer to the same or like parts.

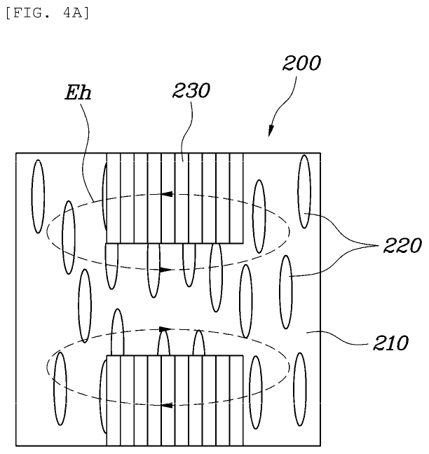

FIG. 3 is a view illustrating a magneto-rheological elastomer according to an embodiment of the present disclosure.

As illustrated in FIG. 3, the magneto-rheological elastomer 100 according to an embodiment of the present disclosure includes an elastomer substrate 110 having a predetermined shape, magnetic powder 120 included in the elastomer substrate 110, and a coil 130 disposed inside to be embedded in the elastomer substrate 110.

The elastomer substrate 110, which is a component functioning to offer elastic force and to define the shape of the magneto-rheological elastomer 100, may be made of natural rubber. As the material that constitutes the elastomer substrate 110, various kinds of synthetic resin having elasticity may be used; that is, the disclosure is not limited to natural rubber. Furthermore, various kinds of materials that are capable of being applied to a usual magneto-rheological elastomer may be used.

The magnetic powder 120 is an element that is included in the elastomer substrate 110 so as to change the modulus of the elastomer substrate 110 and to show a magneto-rheological effect by means of the magnetic field generated by the coil 130. Hence, in order to improve the magnetic properties of the magneto-rheological elastomer, a method of increasing the amount of magnetic powder has conventionally been applied.

In contrast, the embodiment of the present disclosure can improve the magnetic properties of the magneto-rheological elastomer 100 using a relatively small amount of the magnetic powder 120, which is anisotropic.

Specifically, the embodiment may apply magnetic powder that includes flaky particles as the magnetic powder 120. The magnetic powder 120 including the flaky particles offers anisotropy due to its shape. Therefore, the magnetic powder 120 including flaky particles may be included such that the flat surface thereof is oriented so as to be perpendicular to the direction in which stress is applied to the elastomer substrate 110. Here, the magnetic powder 120 including the flaky particles may be embodied by sendust flakes.

The coil 130, which is an element for generating a magnetic field by application of power, may be used in the state of being wound into a circular shape having a size corresponding to that of the elastomer substrate 110. Here, the coil 130 may be wound in a direction perpendicular to the direction in which stress is applied to the elastomer substrate 110.

Consequently, the direction in which the coil 130 is wound may be parallel to the flat surface of the magnetic powder 120. The elastomer substrate 110 may be controlled to be reinforced only in the direction in which stress is applied.

When the direction in which stress is applied is, for example, perpendicular to the ground surface, as illustrated in FIG. 3, the elastic powder 120 is included such that the flat surfaces of the sendust flakes are oriented parallel to the ground surface. As a result, when power is applied to the coil 130, a vertical magnetic field Ev, which is perpendicular to the ground surface, is created. Due to the vertical magnetic field Ev, the magnetic powder 120 is provided with magnetic properties, and the damping property of the magneto-rheological elastomer 100 in a vertical direction is thus improved.

By embedding the coil 130, which is wound in a predetermined direction, in the elastomer substrate 110 and by including the magnetic powder 120, which includes the flaky particles, in the elastomer substrate 110, which has anisotropy in a direction corresponding to the direction in which the coil 130 is wound, it is possible to realize a magneto-rheological elastomer 100 having a high damping property in a predetermined direction.

Furthermore, since it is possible to improve magnetic properties by integrally forming the coil 130 and the magnetic powder 120 in the elastomer substrate 110, it is possible to decrease the number of turns of the coil 130, the intensity of current, and the volume of the elastomer substrate 110 compared to a conventional magneto-rheological elastomer 40, in which the magneto-rheological elastomer 40 and the coil 31 are provided separately.

In addition, since the coil 130 is integrally formed with the elastomer substrate 110 including the elastic powder 120 therein so as to prevent leakage of an electromagnetic field, it is possible to suppress the influence on peripheral components of the magneto-rheological elastomer 100 due to the leakage of the electromagnetic field.

Here, the magneto-rheological elastomer may be variously embodied by changing the direction and number of turns of the coil and the shape of the magnetic powder.

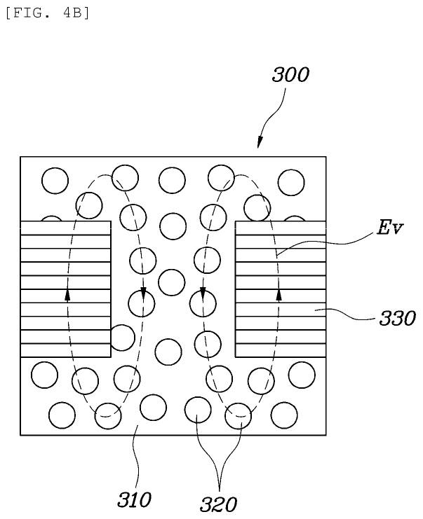

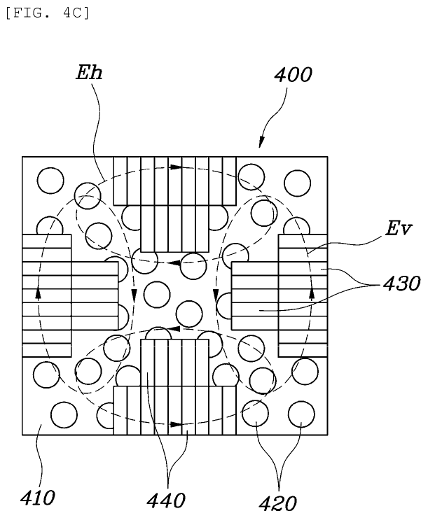

FIGS. 4A to 4C are views illustrating magneto-rheological elastomers according to other embodiments of the present disclosure.

When stress is applied, for example, in a direction parallel to the ground surface, as illustrated in FIG. 4A, the coil 230, which is embedded in the elastomer substrate 210, is wound in a direction perpendicular to the ground surface, and the magnetic powder 220 may be included in the elastomer substrate 210 such that the flat surfaces of the sendust flakes are perpendicular to the ground surface. As a result, when power is applied to the coil 230, a horizontal magnetic field Eh parallel to the ground surface is created, and the magnetic powder 220 is imparted with magnetic properties due to the horizontal magnetic field EH, with the result that the damping property of the magneto-rheological elastomer 200 in a direction parallel to the ground surface is improved.

The magnetic powder is not limited to the magnetic powder including the flaky particles, and magnetic powder including spherical particles may also be used.

When stress is applied, for example, in a direction perpendicular to the ground surface, as illustrated in FIG. 4B, the coil 330, which is embedded in the elastomer substrate 310, is wound in a direction parallel to the ground surface, and the magnetic powder 320 including the spherical particles may be included in the elastomer substrate 310. As a result, when power is applied to the coil 330, a vertical magnetic field Ev perpendicular to the ground surface is created, and the magnetic powder 320 is provided with magnetic properties due to the vertical magnetic field Ev, with the result that the damping property of the magneto-rheological elastomer 300 in a direction perpendicular to the ground surface is improved.

Further, it is possible to realize a damping effect that is selectively reinforced in various directions rather than being reinforced in a certain direction.

As illustrated in FIG. 4C, by embedding a plurality of coils 430 and 440, which are wound in different directions, in the elastomer substrate 410 and by applying power to a selected one of the plurality of coils 430 and 440 as needed, it is possible to reinforce a damping effect in a desired direction.

In this case, because the damping effect must be reinforced in various directions, the magnetic powder 420 may include the spherical particles in the elastomer substrate 410 rather than using magnetic powder including flaky particles and having anisotropy.

For example, the first coil 430, which is wound in a direction parallel to the ground surface, and the second coil 440, which is wound in a direction perpendicular to the ground surface, are embedded in the elastomer substrate 410 including therein the magnetic powder 420 including spherical particles, as illustrated in FIG. 4C.

Consequently, when stress is applied in a direction perpendicular to the ground surface, power is applied to the first coil 430, which is wound in a direction parallel to the ground surface, so as to create the vertical magnetic field Ev perpendicular to the ground surface, thereby reinforcing a damping effect in a direction perpendicular to the ground surface.

When stress is applied in a direction parallel to the ground surface, power is applied to the second coil 440, which is wound in a direction perpendicular to the ground surface, so as to create a horizontal magnetic field Eh parallel to the ground surface, thereby reinforcing a damping effect in a direction parallel to the ground surface.

Although two coils 430 and 440, which are wound in two directions, are embedded in the elastomer substrate 410 in order to reinforce damping effects in the two directions, that is, in directions perpendicular and parallel to the ground surface, as illustrated in FIG. 4C, it is also possible to reinforce damping effects in a greater number of directions by setting the number and turning directions of the coils according to the number of desired directions.

As is apparent from the above description, according to the embodiments of the present disclosure, it is possible to realize a magneto-rheological elastomer, the magnetic properties of which are improved, by directly embedding a coil, which creates a magnetic field upon application of power, in an elastomer substrate.

Specifically, it is possible to realize a magneto-rheological elastomer having improved damping properties in a certain direction by embedding the coil, which is wound in a direction perpendicular to the direction in which stress is applied to the elastomer substrate.

Furthermore, it is possible to realize a magneto-rheological elastomer having further improved damping properties in a certain direction by including anisotropic magnetic powder including flaky particles, oriented in a direction corresponding to the direction in which the coils are wound, in the elastomer substrate.

In addition, it is possible to realize a magneto-rheological elastomer exhibiting improved damping properties in a desired direction by embedding a plurality of coils, which are wound in different directions, in the elastomer substrate and selectively applying power to a desired coil.

Further, it is possible to prevent an electromagnetic field from leaking to peripheral components by embedding the coil in the elastomer substrate to thus directly create a magnetic field in the magneto-rheological elastomer.

Although the preferred embodiments of the present disclosure have been disclosed for illustrative purposes, those skilled in the art will appreciate that various modifications, additions and substitutions are possible, without departing from the scope and spirit of the invention as disclosed in the accompanying claims.

What is claimed is:

1. A coil-integrated magneto-rheological elastomer comprising:
an elastomer substrate having a predetermined shape and comprising a magnetic powder; and
a coil disposed inside the elastomer substrate.

2. The coil-integrated magneto-rheological elastomer according to claim 1, wherein the coil is wound in a direction perpendicular to a direction in which stress is applied to the elastomer substrate.

3. The coil-integrated magneto-rheological elastomer according to claim 2, wherein the magnetic powder includes flaky particles, and
wherein the magnetic powder is configured to be disposed inside the elastomer substrate such that a flat surface of the magnetic powder including the flaky particles is perpendicular to the direction in which the stress is applied to the elastomer substrate.

4. The coil-integrated magneto-rheological elastomer according to claim 2, wherein the magnetic powder includes spherical particles.

5. The coil-integrated magneto-rheological elastomer according to claim 1, wherein the coil includes a plurality of coils, which are wound in different directions from each other.

6. The coil-integrated magneto-rheological elastomer according to claim 5, wherein the magnetic powder includes spherical particles.

7. The coil-integrated magneto-rheological elastomer according to claim 3, wherein the coil is wound in a direction perpendicular to a ground surface, and
wherein the flat surface of the magnetic powder is perpendicular to the ground surface.

8. The coil-integrated magneto-rheological elastomer according to claim 4, wherein the coil is wound in a direction parallel to a ground surface.

9. The coil-integrated magneto-rheological elastomer according to claim 5, wherein one coil among the plurality of coils is wound in a direction parallel to a ground surface, and
another coil among the plurality of coils is wound in a direction perpendicular to the ground surface.
